(19) United States
(12) Patent Application Publication
(10) Pub. No.: US 2025/0281883 A1
(43) Pub. Date: Sep. 11, 2025

(54) MULTISTAGE CROSS-FLOW MEMBRANE FILTRATION SYSTEM AND A METHOD FOR CLEANING SUCH A SYSTEM

(71) Applicant: GEA Systems North America LLC, Hudson, WI (US)

(72) Inventors: Michael E. Roberts, Hudson, WI (US); Daniel Huppert, Eagan, MN (US); Shanti Bhushan, Woodbury, MN (US)

(73) Assignee: GEA Systems North America LLC, Hudson, WI (US)

(21) Appl. No.: 18/599,562

(22) Filed: Mar. 8, 2024

(51) Int. Cl. B01D 65/02; B01D 61/14

(52) U.S. Cl. CPC B01D 65/02; B01D 61/146; B01D 2313/243; B01D 2315/10; B01D 2317/025; B01D 2317/04; B01D 2321/02; B01D 2321/12

(57) ABSTRACT

A multistage cross-flow membrane filtration system and a method for cleaning such a system may be provided. The multistage cross-flow membrane filtration comprises a plurality of membrane stages the permeate outlets of which are selectively connectable to a downstream membrane stage and the cleaning method comprises supplying liquid permeate from at least one membrane stage to at least one downstream membrane stage.

### TECHNICAL FIELD

The present invention relates to cleaning of multistage membrane filtration systems.

### BACKGROUND ART

Multistage cross-flow membrane filtration systems are used for separation processes for a wide range of chemical and biochemical products, including dairy, beverage, pharmaceutical and food products. Membranes of different type and pore sizes are used depending on the separation requirements. Common membrane element configurations include spiral, hollow fiber, tubular inorganic, and tubular polymeric. The membrane separation cut-off is typically categorized as microfiltration (MF), ultrafiltration (UF), nanofiltration (NF) or reverse osmosis (RO).

A multistage system as used herein is a membrane filtration system comprising a plurality of membrane stages, each having at least one membrane which are connected in series. Feed is introduced to the upstream stage, where a separation occurs across the membrane, generating a retentate and permeate fraction. Permeate is removed from the stage and retentate is directed to the next stage in series. In this manner, the feed material is continually fractionated as the retentate progresses through the stages in series where it is ultimately removed from the system at the desired concentration level. Some membrane processes utilize diafiltration, which is the injection of a solvent, typically water, into the membrane separation stages in order to allow for a higher fractionation of permeable components into the permeate stream.

During production, material present in the feed will deposit as foulant on the membrane surface. In order to restore performance, production is interrupted for cleaning routines, typically in the form of cleaning-in-place (CIP) routine where various cleaning liquids are circulated through the multistage membrane filtration systems. Typically a CIP system is connected to the membrane filtration system and a sequence of cleaning steps are executed. The frequency and nature of the CIP procedure varies across products and industries. CIP is often done at product/batch change-over and/or at regular intervals. A general CIP procedure could have the steps: flush with water, wash with alkali, flush with water, wash with acid, flush with water and final flush with water. In this manner, foulants are removed from the membrane surface during the chemical recirculation steps and removed from the system during the flushing step.

While CIP procedures are effective, they can involve a significant use of flushing liquids, entailing both an operational cost and environmental impact. It is therefore desirable to reduce the use of cleaning liquids. One way to do this is to recycle spent cleaning liquids into the CIP system for re-use. The CIP system may even have units for cleaning the spent cleaning liquids. While such recycling can reduce the volume of cleaning liquids, recycling may not be possible for all cleaning liquids or cleaning steps.

Multistage membrane filtration systems are typically used for large production capacities. The CIP-systems may not have the capacity to deliver sufficient volume of flushing liquid allowing all of the stages to be flushed simultaneously. Hence, multistage systems are often flushed sequentially by flushing one subset of the membrane stages at a time, according to the available capacity of flushing liquid, leading to increased flushing times.

Hence, it is an object of the invention to provide an alternative and/or improved method to flush multistage membrane filtration systems, which method may have improved flushing liquid consumption and/or improved cleaning time.

### SUMMARY OF THE INVENTION

This and further objects are achieved by the invention as defined in the appended claims. Thus, according to a first aspect of the present invention there is provided a method for cleaning a multistage cross-flow membrane filtration system, which multistage membrane filtration system comprises a baseline, a feed pump configured to supply liquid to the baseline, and a plurality of membrane stages connected to the baseline,
wherein each membrane stage comprises at least one cross-flow membrane having a retentate side and a permeate side, an inlet connected to the baseline and to the retentate side, a retentate outlet connected to the baseline and to the retentate side, a permeate outlet connected to the permeate side, and a loop pump configured to supply liquid from the baseline through the inlet to the retentate side and across the at least one cross-flow membrane to the permeate side,
which method comprises the steps of:
a) connecting the baseline to a source of cleaning liquid,
b) supplying cleaning liquid from the baseline to at least one of the membrane stages, thereby generating retentate and permeate,
c) supplying at least part of the permeate from the at least one membrane stage to at least one downstream membrane stages.

By routing at least part of the permeate from at least one membrane stage to at least one downstream membrane stage, the cleaning liquid which has already been used to clean a membrane stage is reused in at least one further membrane stage, thus increasing the utilization of the cleaning liquid.

It will be understood that the reference to cleaning encompasses any suitable cleaning procedure. For example, flushing, which is particularly relevant in the context of CIP processes. The method for cleaning can therefore be considered in some embodiments as a method for flushing.

Step c) of supplying at least part of the permeate to at least one downstream membrane stage may be achieved in any suitable way, for example by supplying at least part of the permeate to the retentate side of a downstream membrane stage. Preferably in some embodiments the at least part of the permeate is supplied to the inlet(s) of the at least one downstream membrane stages. It will be understood that in practice some or even most of the fluid exiting a membrane stage can be fed back into the same membrane stage to support recirculation. This recirculation adds flexibility to the selection of the point at which permeates from an upstream membrane stage are added to the membrane stage since the recirculation means that the permeates will pass through the membrane stage regardless of which point within the membrane stage they are added.

It will be understood that the terms upstream and downstream refer to positions relative to the source of cleaning liquid, with the source being the most upstream position and positions in the direction away from the source of cleaning liquid being considered downstream. Thus, a membrane stage is considered downstream of another membrane stage when it is further from the source of the cleaning liquid.

In some embodiments all of the permeate from at least one membrane stage is supplied to at least one downstream membrane stage. Thus, more of the cleaning fluid is reused compared with embodiments in which only part of the cleaning fluid is supplied to one or more downstream membrane stages.

Permeate from a plurality of membrane stages, such as two membrane stages, may be combined and supplied to at least one downstream membrane stage. Combining permeate in this way can simplify the apparatus which in turn can reduce associated costs.

Step c) can generate further permeate as the liquid flows across the cross-flow membrane. Thus, the method may further comprise the step of:
d) supplying at least part of the further permeate from at least one membrane stage to at least one further downstream membrane stage. As a result, the extent of the reuse of cleaning fluid is increased further.

Step d) also generates permeate. The method may therefore further comprise the step of supplying at least part of the permeate generated in step d) to at least one further downstream membrane stage. Again, the extent of the reuse of the cleaning fluid is increased yet further.

In some embodiments the permeate outlet of each membrane stage is selectively connected to at least one other downstream membrane stage. This can improve process efficiency as it allows cleaning fluid to be efficiently directed to the next stage where it is required/desired. However, in other embodiments the permeate outlet can be connected to any part of the subsequent membrane stage.

Where the permeate outlet of each membrane stage is selectively connected to the inlet of at least one other membrane stage, the permeate outlets of each membrane stage may be selectively connected to the inlet of the at least one other membrane stage by way of the baseline and permeate is transported via the baseline.

It will be understood that transport of permeate between membrane stages by way of the baseline is beneficial in some embodiments as it obviates the need for additional pipework, which in turn can reduce costs. However, it is not essential that the permeate be transported via the baseline and alternative means can be used to transport permeate(s) to onward membrane stages.

Generally, those permeates generated in the cleaning method and which are returned to the membrane filtration system, are returned at a position downstream of the feed pump of the system and downstream of the stage(s) where they are created. This can be by returning the permeates to the baseline, downstream of the feed pump and the creation stage(s), or by returning them into the filtration system by returning them directly to another downstream membrane stage, for example the inlet. This is in contrast to cleaning methods where the permeate(s) are recycled to the source of cleaning liquid, in effect recycling the permeates into the entire filtration system, or alternatively sending the permeates directly to the drain. In the methods according to the invention, the permeate(s) are rather cascaded through the membrane filtration system, passing sequentially through the membrane filtration system.

In some embodiments, each membrane stage may comprise a plurality of parallel membranes connected to the inlet, to the retentate outlet and to the permeate outlet of the membrane stage.

Each membrane stage may independently comprise one, two, three, four or five membrane units. Each membrane stage may have the same number of membrane units as every other stage. Alternatively, some but not all stages may have the same number of membrane units. Alternatively, no two stages may have the same number of membrane units.

In some embodiments the multistage membrane filtration stage has six membrane stages.

In such embodiments, permeate from the first two membrane stages can be combined and supplied to the next two membrane stages. This grouping of membrane stages can help to simplify the procedure.

Further, permeate from the next two membrane stages may be combined and supplied to the final two membrane stages.

In some embodiments every membrane stage except the first receives permeate from an upstream membrane stage. In this way, cleaning fluid is recycled since every membrane stage except the first is contacted with cleaning fluid which has already cleaned at least one other membrane stage. It is often the case that membrane stages receive permeate from the membrane stage that is adjacent and upstream, but this is not essential and in some embodiments some membrane stages can be skipped or bypassed.

It will be understood that the methods of the present invention may be performed as part of a cleaning-in-place procedure.

The cleaning liquid may be any suitable cleaning liquid. For example, the cleaning liquid may be water, ethanol, an alkaline liquid or an acidic liquid.

Preferably the cleaning liquid is water, and the method is for flushing a target compound from the membrane filtration system.

The multistage membrane filtration system may be an MF, UF, NF or RO membrane filtration system. Preferably, the multistage membrane filtration system is an MF, UF or NF system. Any suitable cross-flow membrane configuration may be used, for example spiral such as spiral polymeric, tubular such as tubular organic or tubular polymeric, or hollow fiber.

According to a second aspect of the present invention there is provided a multistage cross-flow membrane filtration system configured for performing the method according to the first aspect of the invention,
wherein the multistage membrane filtration system comprises a baseline, a feed pump configured to supply liquid to the baseline, a plurality of membrane stages connected to the baseline, and a common permeate line,
each membrane stage comprises at least one cross-flow membrane having a retentate side and a permeate side, an inlet connected to the baseline and to the retentate side, a retentate outlet connected to the baseline and to the retentate side, and a loop pump configured to supply liquid from the baseline through the inlet to the retentate side and across the at least one cross-flow membrane to the permeate side, characterized in that the permeate outlet(s) of at least one of the membrane stages are connected to a respective permeate pump and a valve arrangement,
wherein the valve arrangement is operable to selectively connect the permeate outlet(s) to the common permeate line or to the inlet(s) of at least one other downstream membrane stage.

Thus, the apparatus is configured to allow cleaning fluid to pass from one membrane to another and thereby facilitate enhanced utilization of the cleaning liquid.

The valve arrangement may be operable to selectively connect the permeate outlet(s) to the inlet(s) of the at least one other membrane stage, through the baseline.

There may be any suitable number of membrane stages. In the simplest form, there are two membrane stages. In this way permeate from the first membrane stage can be reused in the second.

In some embodiments there are six membrane stages. Preferably there are three membrane units per membrane stage, but there may be any suitable number per stage.

### BRIEF DESCRIPTION OF DRAWINGS

In the following the invention will be described with reference to the exemplary embodiments shown in the enclosed drawings, in which:

FIG. 1 shows a schematic of a first multistage membrane filtration system according to the invention;

FIG. 2 shows a schematic of a second multistage membrane filtration system according to the invention; and

FIG. 3 shows a schematic of a third multistage membrane filtration system according to the invention.

Each membrane filtration system is configured for the cleaning method according to the invention.

### DETAILED DESCRIPTION

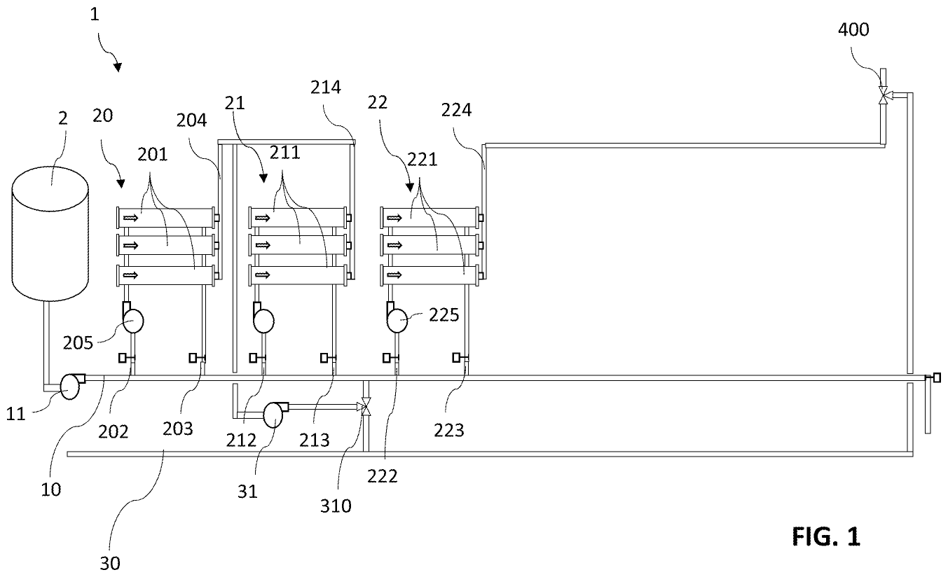

Referring initially to FIG. 1, which shows an embodiment of a multistage membrane filtration system 1 (“the system”). The system 1 is shown in all figures in a schematic manner where the components pertinent to the invention are shown but leaving out components not necessary to explain the invention. Hence, the system 1 will in practice further comprise components and instrumentation other than those shown in the figures, such as pumps, valves, heat exchangers, discharge ports etc. as will be appreciated by the skilled practitioner.

As shown in FIG. 1 the system 1 comprises a baseline 10 which has feed pump 11 positioned at an upstream position on the baseline, which is a conduit for liquid. The feed pump 11 is configured to supply liquid to the baseline 10. The liquid is supplied from source 2, which in this embodiment is shown as a tank, but could equally be a continuous supply of cleaning liquid, such as a central clean water supply.

In this embodiment three membrane stages 20-22 are arranged on the baseline 10 each of which has an inlet 202, 212, 222, which connects a retentate side of the respective membrane stages to the baseline 10. As seen from the feed pump and downstream the membrane stages are denoted a first membrane stage 20, a second membrane stage 21, and a third membrane stage 22. The retentate side of each of the membrane stages also has a retentate outlet 203, 213, 223, which, in this embodiment, is also connected to the baseline 10.

In this embodiment, each membrane stage comprises three membrane units 201, 211, 221, arranged in parallel and each connected to their respective inlets. These membrane units house membranes which can be of any cross-flow membrane type.

In the embodiment shown the permeate from permeate outlets 204 and 214 of the first two membrane stages 20, 21 respectively is combined and transported to a single permeate pump 31. From here the permeate can be transported for use in the third membrane stage 22.

The combining of permeates in this way will vary between applications. Where three membrane stages are present, the system could alternatively be arranged so that permeates are not combined. That is, in this alternative configuration of the apparatus of FIG. 1 permeate from the first membrane stage 20 would pass to the second membrane stage 21 thereby generating further permeate, which itself could then be transported to the third membrane stage 22.

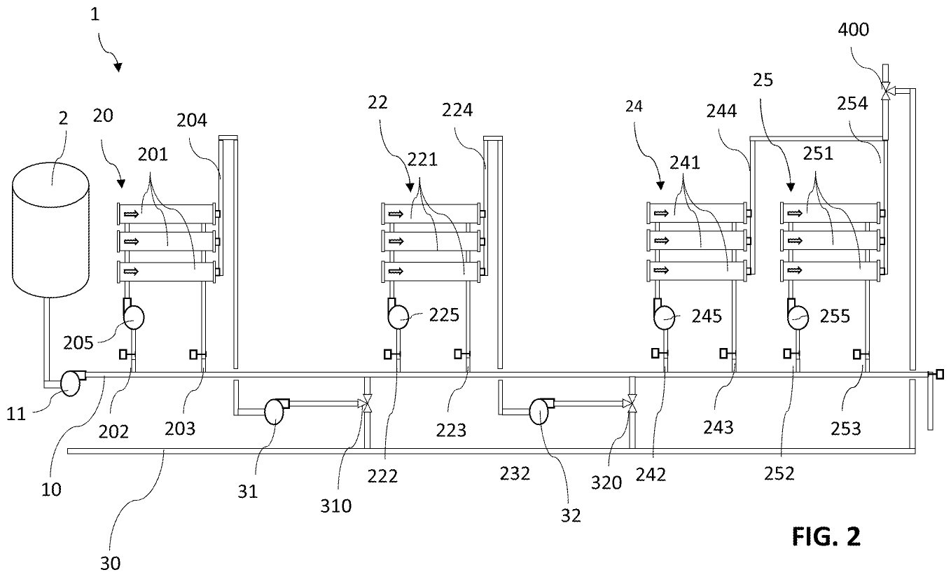

An alternative configuration is shown in FIG. 2. In this embodiment four membrane stages 20, 22, 24, 25 are present. In this embodiment, only permeate from the final two membrane stages 24, 25 is combined.

It will be understood that in its very simplest form, an alternative arrangement would have two membrane stages. In this arrangement, permeate from the first membrane stage would be used in the second membrane stage. That said, typically systems used on commercial scales will often comprise more membrane stages.

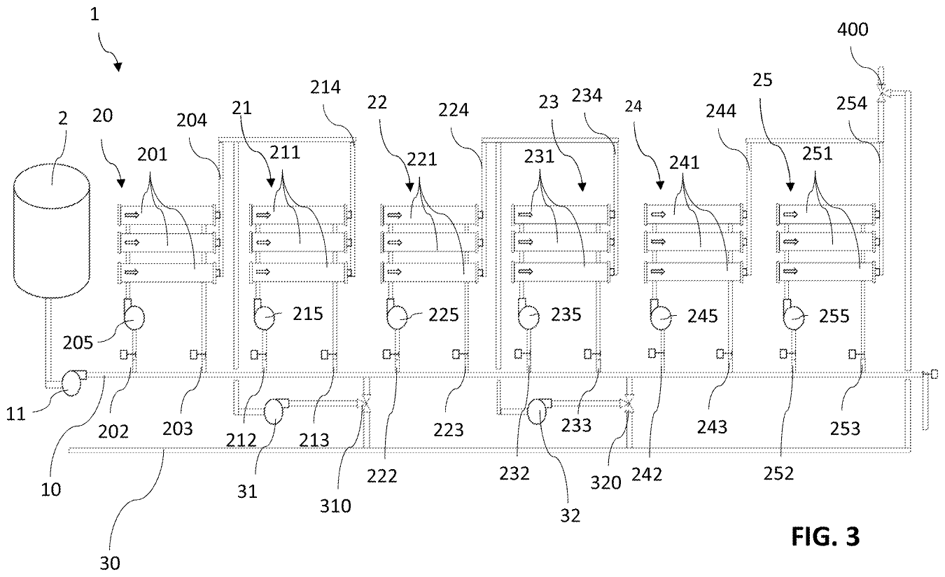

Referring now to FIG. 3, this shows an alternative arrangement in which the system comprises six membrane stages. In the embodiment shown, each membrane stage comprises three membrane units. However, it will be understood that the membrane stages could comprise more, or fewer membrane units and each membrane stage need not comprise the same number of membrane units as other membrane stages. The operation of the system will be described in more detail in connection with FIG. 3.

The system 1 comprises a baseline 10 which has feed pump 11 positioned at an upstream position on the baseline, which is a conduit for liquid. The feed pump 11 is configured to supply liquid to the base line 10. The liquid is supplied from source 2, which in this embodiment is shown as a tank, but could equally be a continuous supply of cleaning liquid, such as a central clean water supply.

A plurality of membrane stages 20-25 is arranged on the baseline 10 each of which has an inlet 202, 212, 222, 232, 242, 252 which connects a retentate side of the respective membrane stages to the baseline 10. As seen from the feed pump and downstream the membrane stages are denoted a first membrane stage 20, a second membrane stage 21, a third membrane stage 22, a fourth membrane stage 23, a fifth membrane stage 24, and a sixth membrane stage 25. The retentate side of each of the membrane stages also has a retentate outlet 203, 213, 223, 233, 243, 253, which, in this embodiment, is also connected to the baseline 10.

In this embodiment, each membrane stage comprises three membrane units 201, 211, 221, 231, 241, 251 arranged in parallel, each connected to their respective inlets. These membrane units house membranes and can be of any cross-flow membrane type, for example spiral such as spiral polymeric, tubular such as tubular organic or tubular polymeric, or hollow fiber. Similarly, the membrane can be an MF, UF, NF or RO membrane.

In production mode, where a feed is being filtrated, feed pump 11 supplies the feed to the baseline 10 and a loop pump 205, 215, 225, 235, 245, 255 of each membrane stage contributes to supplying feed to the retentate side of each membrane through the respective inlets, a portion of which feed passes through membrane in the membrane unit 201, 211, 221, 231, 241, 251, which portion is a production permeate, and leaving a portion on the retentate side which passes through the respective retentate outlets as a production retentate and back into the baseline 10. Some production retentates then pass from the baseline to a downstream membrane stage, whereas some are returned to the same stage to support recirculation. In many cases the majority of the production retentates (by volume) may be returned to the same stage for recirculation with a minority passing downstream.

A final retentate portion can be collected at the downstream end of the baseline 10 opposite to the feed pump 11. On the permeate side of the membrane stages there is a permeate outlet 204, 214, 224, 234, 244, 254 for collecting the permeates. The permeate outlets 204, 214, 224, 234, 244, 254 are selectively connected to a common permeate line 30 through valve arrangements 310, 320 and 400, which in this embodiment is three-way valves. Hence, in production mode, the production permeates can be routed from each of the permeate outlets 204, 214, 224, 234, 244, 254 to the common permeate line 30 to collect the production permeate. Permeate pumps 31, 32 for are provided for this purpose.

Having described the system 1 and its operation during production, i.e. a filtration process, we turn to the method for cleaning the system 1. The system 1 will need cleaning at regular intervals, due to fouling, batch change over or line cleaning. This is typically done by a cleaning-in-place (CIP) routine where a series of cleaning liquids are circulated through the system 1. A typical CIP routine comprises water flushes, acid washes, and alkaline washes, and sometimes more advanced cleaning agents such as enzyme-based cleaning agents. A step of conserving in e.g. ethanol is sometimes needed.

Cleaning liquids as used herein comprises these cleaning liquids and water comprises potable water, purified water and water for injection.

When cleaning the system 1 the source 2 of cleaning liquid is connected to the baseline, which source 2 can be a CIP-system. In the system 1 of FIG. 3, the membrane stages can be considered as being arranged in three subsets, with a first subset having the two upstream membrane stages 20, 21, a second subset having the downstream membrane stages 22, 23 and the third subset having the most downstream membrane stages 24, 25. The subsets are indicated by the grouping of the connection of the permeate outlets 204, 214, 224, 234, 244, 254 to the valve arrangements 310, 320, 400.

Where membrane stages are grouped in this way, the number of membrane stages in each subset can be determined by the available capacity (flow rate) of cleaning liquid from the source 2 and the type of membrane used in the system. With a low cleaning liquid capacity only a few membrane stages can receive cleaning liquid from the baseline at the same time, but more capacity increases the number of stages which can receive cleaning liquid. Similarly, a large pore size membrane leaves less retentate than a smaller pore size membrane or more permeate, again leaving less cleaning liquid in the baseline for downstream stages.

In the embodiment shown, the source 2 can supply cleaning liquid for two membrane stages, and the membrane stages are grouped in pairs, resulting in three subsets. Given more capacity, the system could be arranged in two subsets of three membrane stages each. Given less capacity, there could be no grouping of the membrane stages.

For a filtration system with a plurality of membrane stages, any number of subsets each having any number of membrane stages is conceivable, in the event that it is desirable to group at least some of the membrane stages. Although currently considered practical, the subsets do not need to have the same number of membrane stages.

Returning to FIG. 3, it can be seen that the permeate pumps 31 and 32 and associated valve arrangements 310 and 320 are provided for the first two membrane stages 21-22, and for the second two membrane stages 23-24 respectively. In the embodiment show, the valve arrangements 310, 320 are configured to provide selective connection of the respective permeate outlets 204, 214 and 224, 234 to the baseline 10 in addition to the aforementioned selective connection to the common permeate line 30. Hence, selective connection refers to the possibility of selecting a routing option of the permeate outlets to the baseline 10 or the common permeate line 30. The valve arrangements 310, 320 may thus comprise a first position providing fluid communication from the permeate outlets to the common permeate line 30 and a second position providing fluid communication from the permeate outlets to base line 10.

As will be clear from the description of the cleaning operation below, the valve arrangements 310, 320 do not need to provide the connection to the baseline 10, but can also provide connection directly to one or more other membrane stages, for example via the inlets of the relevant stages, instead of having fluid communication through the baseline 10. Hence, valve arrangement 310 could connect directly to the inlets 222, 232 of the second membrane stages (not shown).

As shown in FIG. 3, the valve arrangements 310, 320 can connect to the baseline 10 immediately downstream of the respective membrane stages 20-21, 22-23, as seen from the source 2, which provides a simple design, but this is not essential.

It will be understood that in general, not just in the specific embodiments shown, one or more membrane stages may be bypassed. That is to say, permeate need not necessarily travel to an adjacent downstream membrane stage, but could travel to one further downstream if the adjacent one(s) are to be bypassed. The bypass could be provided by a dedicated bypass line, or by valve arrangements which allow the required isolation. In the context of FIG. 3, this could mean for example that membrane stages 22, 23 are bypassed, such that permeate from membrane stages 20, 21 pass instead from permeate outlets 204, 214 to the membrane stages 24 and 25.

The valve arrangement 400 of the membrane stages 24 and 25 does not provide selective communication to the baseline, but to a further line, which would be a discharge port. The valve arrangement 400 is not essential, and the permeate outlets 244, 254 could in alternative to the embodiment show be connected to the common permeate outlet without the valve 400.

The arrangement of the filtration system 1 with the permeate pumps 31, 32 and valve arrangements 310 and 320 allow for directing liquid from the permeate side of the membrane stages to the inlets of downstream membrane stages, which in the shown embodiment is achieved through the baseline 10. This allows for an improved cleaning method according to the invention, which will be described with reference the system of FIG. 3.

In the cleaning method, the system 1 is connected to the source 2 of cleaning liquid by way of the baseline 10. The feed pump 11 is activated to supply cleaning liquid to the baseline 10. This feed pump can form part of the system 1 as in the embodiment of FIG. 1 but could conceivably be part of a system comprising the source 2, such as CIP-system. Cleaning liquid from the baseline 10 is supplied to the first two membrane stages 20, 21 through the respective inlets 202, 212, further supported by the loop pumps 205, 215 of each membrane stage. As discussed, the number of membrane stages in the first subset is given by the capacity of source 2, hence the flow of cleaning liquid remaining in the baseline immediately downstream of inlet 212 is small.

Supplying the cleaning liquid to the membrane units 201, 211 generates retentate which will return to the baseline 10 through the retentate outlets 203, 213. The amount of retentate varies with the type of membranes, where membranes with a comparatively large pore size provides small retentate portions, while smaller pore sizes conversely retain more cleaning liquid, providing larger retentate quantities.

In the embodiment of FIG. 3, each of the three parallel membrane units 201 in the first membrane stage 21 and each of the three parallel membrane units 211 in the second membrane stage 22, generate respective retentates. A portion of the cleaning liquid passes through the membranes, generating permeate in each of the membrane units 201 and membrane units 211.

In the apparatus of FIG. 3, permeates are provided in the permeate outlets 204, 214 respectively. The permeates from the first two membrane stages 20-21 is collected and directed to the valve arrangement 310 by way of permeate pump 31. In cleaning mode, the valve arrangement 310 is positioned to provide fluid communication to the baseline 10, hence the permeates are returned to the baseline 10 at a position downstream of the first two membrane stages 20-21. In this way, the permeates are supplied to the inlets 222, 232 of the next two membrane stages 22-23, alongside remaining cleaning liquid in the baseline 10, if any, and the retentates from the first two membrane stages 20-21. Analogously to the manner described above, the loop pumps 225, 235 direct the cleaning liquid, which includes the permeates, to the next two membrane stages 22-23, generating retentates which return to the baseline 10 through retentate outlets 223, 233, and permeates which are collectively directed to the valve arrangement by way of permeate pump 32. In this way, the cleaning liquid which has been used to clean the first two membrane stages 20-21, is re-used to clean the next two membrane stages 22-23, reducing the consumption of cleaning liquid. To further reduce the consumption of cleaning liquid, the valve arrangement 320 can direct the permeates to the inlets 242, 252 of the final two membrane stages 24-25, which in the embodiment of FIG. 3 is achieved by the valve arrangement 320 being positioned to provide fluid communication between the permeate outlets 224, 234 and the baseline 10. The permeates are thus used yet again to clean the membrane stages 24-25, whereby the permeates from the first two membrane stages passed through all the remaining membrane stages. The cleaning of the final membrane stages 24-25 operates in analogous manner, where loop pumps 245, 255 direct cleaning liquid from the inlets 242, 252 to the membrane units 241, 251, generating retentates in the retentate outlets 243, 253 and permeates in the permeate outlets 244, 254. Hence, cleaning step of the final membrane stages 24-25 can be considered a repeat of the cleaning step of the membrane stages 22-23, seeing as previously used cleaning liquid is used in both.

If system 1 was arranged with a different grouping of the permeate outlets, the cleaning step could still be repeated for all membrane stages, with the permeate generated from each step cascading through the system.

As can be seen in FIG. 3 the valve arrangement 400 does not provide selective fluid communication to the baseline 10, as the membrane stages 24-25 are the final ones and there are no further membrane stages to clean. During cleaning the valve arrangement 400 is positioned to send the permeates to be discharged from the system, which in the embodiment of FIG. 3 may be the valve arrangement 400 blocking the path to the common permeate line 30, or by using the common permeate line 30 as a discharge line seeing as the valve arrangements 310, 320 are blocked towards the common permeate line during cleaning.

In the embodiment of FIG. 3, all subsets 20-21, 22-23 of membrane stages but one, the third subset 24-25, return their permeates for cleaning of further membrane stages. This is presently considered to provide the greatest improvement in efficiency in terms of cleaning solution consumption, but it will be appreciated that lesser, but potentially significant improvements can be obtained with part of the permeates being returned and/or even if only the permeate of the first membrane stage or subset 20-21 is re-used.

When it is determined that cleaning of the first two membrane stages 20-21 is complete, one option is to continue to supply cleaning liquid to the first two membrane stages 20-21, until the permeates have completed the cleaning of next two membrane stages 22-23 and of the final two membrane stages 24-25. This provides a simple method where pumps and valve positions are not activated or deactivated during the process. Another option is to cycle through the membrane stages by isolating the membrane stages for which it has been determined that cleaning has been completed, cutting off the supply of cleaning liquid to the clean stages. Determining when a cleaning step is complete depends on the cleaning step in question, but is within the knowledge of the skilled practitioner. An alkali or acid wash cleaning step may for example be complete at a set time as elapsed or determined by measuring a parameter in the permeate, such as conductivity. Similarly, some water flush cleaning steps are deemed complete after a set elapsed time, while other water flush steps are deemed complete by measuring that a parameter of the permeate has passed a specified threshold, such as a conductivity, absorbance or turbidity.

Returning to FIG. 3 and the option of cycling through membrane stages as the cleaning step is deemed complete. This could be done determining that the cleaning step of the first two membrane stages 20-21 is complete, and then isolating these from the baseline 10, e.g. by deactivating loop pumps 205, 215 and/or with suitably arranged valves. The cleaning liquid from feed pump 11 would than pass directly to the next two membrane stages 22-23 in a second cycle of the cleaning method. Once cleaning of the next two membrane stages 22-23 is deemed complete, they too can be isolated from the baseline 10, starting a third cycle where cleaning liquid is supplied directly to the final two membrane stages 24-25. Cycling in this manner may reduce energy consumption as cleaning liquid is not pumped through clean membrane stages.

To illustrate the advantages of the invention, its application in a water flush step of a cleaning procedure will be described.

The cleaning liquid is water, such purified water or water for injection, and is used to flush the membrane filtration. Water flushes may follow another cleaning step, such as an acid or alkali wash, where the purpose is to flush the former cleaning agent from the system. As example a water flush following an acid wash is considered, where the purpose is to flush a target compound from the system, the target compound being the acid compound.

The clean water is supplied from the source 2 by the feed pump 11 to the first two membrane stages 21-22. As the water passes through the membrane stages the acid compound is removed into the first permeates, which is thus enriched with acid compound, compared to the water entering the first membrane stages. The enriched first permeates is then used to flush acid compound from the next two membrane stages 22-23, and the resulting permeates from the next two membrane stages 22-23 is still further enriched in acid compound. The permeates are then used to flush acid compound from the final two membrane stages 24-25. Thus the permeates, rather than being sent to the drain are re-used to flush the downstream membrane stages, which reduces the consumption of flushing water. When the flush of the first two membrane stages 20-21 is complete, determined for example by measuring the conductivity of the first permeate passing a specified threshold, the supply of water from source 2 can simply continue, whereby the permeates will complete the flush of the next membrane stages in sequence. In an alternative embodiment, the first two membrane stages 20-21 are isolated after determining the flush thereof is completed, e.g. by deactivating loop pumps 205, 215, whereby the water from source 2 is supplied directly to the next two membrane stages.

The reduction in flushing water consumption possible with the method described immediately above has been calculated. The results are shown in Table I alongside a comparative example where each membrane stage is flushed with water and the permeate of each stage is sent to the drain. The water consumption is per single filtration unit in a single flush step and have been normalized to the values comparative example, showing the relative improvement.

TABLE I

| | [Comparative] | [Invention] | |
|---|---|---|---|
| | Estimated flush | Estimated flush | |
| Type of | water | water | Percent |
| system | consumption | consumption | reduction |
| UF/DF | 100 | 60 | 40 |

### LIST OF REFERENCE NUMERALS

1 Multistage cross-flow membrane filtration system
10 Baseline
11 Feed pump
2 Source of cleaning liquid
20 First membrane stage
21 Second membrane stage
22 Third membrane stage
23 Fourth membrane stage
24 Fifth membrane stage
25 Sixth membrane stage
201, 211, 221, 231, 241, 251 Membrane units of respective membrane stages
202, 212, 222, 223, 224, 225 Inlets of respective membrane stages
203, 213, 223, 233, 243, 253 Retentate outlets of respective membrane stages
204, 214, 224, 234, 244, 254 Permeate outlets of respective membrane stages
205, 215, 225, 235, 245, 255 Loop pumps of respective membrane stages
30 Common permeate line
31, 32 Permeate pump
310, 320 Valve arrangement
400 Valve arrangement

### LIST OF ENUMERATED EMBODIMENTS (EES)

EE1. A method for cleaning a multistage cross-flow membrane filtration system
which multistage membrane filtration system comprises a baseline, a feed pump configured to supply liquid to the baseline, and a plurality of membrane stages connected to the baseline,
wherein each membrane stage comprises at least one cross-flow membrane having a retentate side and a permeate side, an inlet connected to the baseline and to the retentate side, a retentate outlet connected to the baseline and to the retentate side, a permeate outlet connected to the permeate side, and a loop pump configured to supply liquid from the baseline through the inlet to the retentate side and across the at least one cross-flow membrane to the permeate side,
which method comprises the steps of:
a) connecting the baseline to a source of cleaning liquid,
b) supplying cleaning liquid from the baseline to at least one of the membrane stages, thereby generating retentate and permeate,
c) supplying at least part of the permeate from at least one membrane stage to at least one downstream membrane stage.

EE2. A method according to EE1, wherein all of the permeate from at least one membrane stage is supplied to at least one downstream membrane stage.

EE3. A method according to any preceding enumerated embodiment, wherein permeates from a plurality of membrane stages, such as two membrane stages, are combined and supplied to at least one downstream membrane stage.

EE4. The method according to any preceding enumerated embodiment, wherein step c) generates further permeate and the method further comprises the step of:
d) supplying at least part of the further permeate from at least one membrane stage to at least one further downstream membrane stage.

EE5. The method according to EE4, wherein step d) generates permeate and the method further comprises the step of supplying at least part of the permeate generated in step d) to at least one further downstream membrane stage.

EE6. The method according to any one of the preceding enumerated embodiments, wherein the permeate outlet of each membrane stage is selectively connected to at least one other downstream membrane stage.

EE7. The method according to EE6, wherein the permeate outlet of each membrane stage is selectively connected to the inlet of the at least one other membrane stage by way of the baseline and permeate is transported from a membrane stage to a downstream membrane stage via the baseline.

EE8. The method according any one the preceding enumerated embodiments, wherein each membrane stage comprises a plurality of parallel membranes connected to the inlet, to the retentate outlet and to the permeate outlet of the membrane stage.

EE9. The method according to any one of the preceding enumerated embodiments, wherein each membrane stage independently comprises one, two, three, four or five membrane units.

EE10. The method according to any preceding enumerated embodiments, wherein the multistage membrane filtration stage has six membrane stages.

EE11. The method according to EE10, wherein permeate from the first two membrane stages is combined and supplied to the next two membrane stages.

EE12. The method according to EE11, wherein permeate from the next two membrane stages is combined and supplied to the final two membrane stages.

EE13. The method according to any preceding enumerated embodiment where every membrane stage except the first receives permeate from an upstream membrane stage.

EE14. The method according to any one of the preceding enumerated embodiments, wherein the method is performed as part of a cleaning-in-place procedure.

EE15. The method according to any one of the preceding enumerated embodiments, wherein the cleaning liquid is water, ethanol, an alkaline liquid or an acidic liquid.

EE16. The method according to any one of the preceding enumerated embodiments, wherein the cleaning liquid is water, and the method is for flushing a target compound from the membrane filtration system.

EE17. The method according to any one of the preceding enumerated embodiments, wherein the multistage membrane filtration system is an MF, UF, NF or RO membrane filtration system, preferably MF, UF or NF system.

EE18. A multistage cross-flow membrane filtration system configured for performing the method according to any one of the preceding claims,
wherein the multistage membrane filtration system comprises a baseline, a feed pump configured to supply liquid to the baseline, a plurality of membrane stages connected to the baseline, and a common permeate line,
each membrane stage comprises at least one cross-flow membrane having a retentate side and a permeate side, an inlet connected to the baseline and to the retentate side, a retentate outlet connected to the baseline and to the retentate side, and a loop pump configured to supply liquid from the baseline through the inlet to the retentate side and across the at least one cross-flow membrane to the permeate side,
characterized in that
the permeate outlet(s) of at least one of the membrane stages are connected to a permeate pump and a valve arrangement,
wherein the valve arrangement is operable to selectively connect the permeate outlet(s) to the common permeate line or to the inlet(s) of at least one other downstream membrane stage.

EE19. The multistage cross-flow membrane filtration system according to EE18, wherein the valve arrangement is operable to selectively connect to the permeate outlet(s) to the inlet(s) of the at least one other membrane stage, through the baseline.

EE20. The multistage cross-flow membrane filtration system according to EE18 or EE19, wherein there are six membrane stages.

1. A method for cleaning a multistage cross-flow membrane filtration system, the multistage cross-flow membrane filtration system comprises a baseline, a feed pump configured to supply liquid to the baseline, and a plurality of membrane stages connected to the baseline,
wherein each of the plurality of membrane stages comprises at least one cross-flow membrane having a retentate side and a permeate side, an inlet connected to the baseline and to the retentate side, a retentate outlet connected to the baseline and to the retentate side, a permeate outlet connected to the permeate side, and a loop pump configured to supply liquid from the baseline through the inlet to the retentate side and across the at least one cross-flow membrane to the permeate side,
wherein the method comprises:
connecting the baseline to a source of cleaning liquid;
supplying the cleaning liquid from the baseline to at least one of the plurality of membrane stages, thereby generating retentate and permeate; and
supplying at least part of the permeate from the at least one of the plurality of membrane stages to at least one downstream membrane stage.

2. The method according to claim 1, wherein all of the permeate from the at least one membrane stage is supplied to the at least one downstream membrane stage.

3. The method according to claim 1, wherein permeates from at least two of the plurality of membrane stages are combined and supplied to the at least one downstream membrane stage.

4. The method according to claim 1, wherein supplying at least part of the permeate from the at least one of the plurality of membrane stages to the at least one downstream membrane stage generates further permeate, and the method further comprises:
supplying at least part of the further permeate from at least one membrane stage to at least one further downstream membrane stage.

5. The method according to claim 4, wherein supplying at least part of the further permeate from the at least one membrane stage to the at least one further downstream membrane stage generates additional permeate and the method further comprises supplying at least part of the additional permeate to at least one further downstream membrane stage.

6. The method according to claim 1, wherein the permeate outlet of each of the plurality of membrane stages is selectively connected to at least one other downstream membrane stage.

7. The method according to claim 6, wherein the permeate outlet of each of the plurality of membrane stages is selectively connected to the inlet of the at least one other downstream membrane stage by way of the baseline and the permeate is transported from a respective membrane stage to a respective downstream membrane stage via the baseline.

8. The method according claim 1, wherein each of the plurality of membrane stages comprises a plurality of parallel membranes connected to the inlet, to the retentate outlet, and to the permeate outlet of the respective membrane stage.

9. The method according to claim 1, wherein each of the plurality of membrane stages independently comprises one, two, three, four, or five membrane units.

10. The method according to claim 1, wherein the multistage membrane filtration stage has six membrane stages.

11. The method according to claim 10, wherein the permeate from the first two membrane stages is combined and supplied to the next two membrane stages.

12. The method according to claim 11, wherein the permeate from the next two membrane stages is combined and supplied to the final two membrane stages.

13. The method according to claim 1, wherein each of the plurality of membrane stages except a first membrane stage receives permeate from an upstream membrane stage.

14. The method according to claim 1, wherein the method is performed as part of a cleaning-in-place procedure.

15. The method according to claim 1, wherein the cleaning liquid is water, ethanol, an alkaline liquid, or an acidic liquid.

16. The method according to claim 1, wherein the cleaning liquid is water, and the method is for flushing a target compound from the multistage cross-flow membrane filtration system.

17. The method according to claim 1, wherein the multistage cross-flow membrane filtration system is an MF, UF, NF, or RO membrane filtration system.

18. A multistage cross-flow membrane filtration system comprising:
a baseline;
a feed pump configured to supply liquid to the baseline;
a plurality of membrane stages connected to the baseline; and
a common permeate line,
wherein each of the plurality of membrane stages comprises:
at least one cross-flow membrane having a retentate side and a permeate side;
an inlet connected to the baseline and to the retentate side;
a retentate outlet connected to the baseline and to the retentate side; and
a loop pump configured to supply liquid from the baseline through the inlet to the retentate side and across the at least one cross-flow membrane to the permeate side,
wherein one or more of the permeate outlets of at least one of the plurality of membrane stages are connected to a permeate pump and a valve arrangement, and wherein the valve arrangement is operable to selectively connect the one or more permeate outlets to the common permeate line or to the respective inlet of at least one other downstream membrane stage.

19. The multistage cross-flow membrane filtration system according to claim 18, wherein the valve arrangement is operable to selectively connect to the one or more permeate outlet or to the respective inlet of the at least one other membrane stage through the baseline.

20. The multistage cross-flow membrane filtration system according to claim 18, wherein the plurality of membrane stages comprises six membrane stages.
